(19) United States
(12) Patent Application Publication
(10) Pub. No.: US 2007/0276946 A1
(43) Pub. Date: Nov. 29, 2007

(54) SYSTEM AND METHOD OF FORWARDING AND SENDER APPROVAL

(76) Inventors: WEN WENDY HSU, Austin, TX (US); Robert H. Detjen, Austin, TX (US); Jan Rogoyski, Pflugerville, TX (US)

Correspondence Address: IBM CORP. (CLG);c/o CARDINAL LAW GROUP, 1603 ORRINGTON AVENUE, SUITE 2000, EVANSTON, IL, 60201, US

(21) Appl. No.: 11/420,038

(22) Filed: May 24, 2006

(51) Int. Cl. G06F 15/16

(52) U.S. Cl. 709/227; 709/203

(57) ABSTRACT

A system and method of operating a communication system including receiving a communication request from a sender to a recipient, determining whether the recipient is in a communication forward mode, and determining communication forwarding information based on the communication request and the communication forwarding mode determination.

### TECHNICAL FIELD

The technical field of this disclosure is communication systems, particularly, communication forwarding systems.

### BACKGROUND OF THE INVENTION

Many communication systems, including, for example, telephones, email, and instant messaging, provide a communication forwarding system. Typically the communication forwarding system allows a user to forward communication requests to a location or number designated by the user.

Although these conventional communications systems provide control and convenience for a recipient, the sender is not alerted that the communication is being forwarded. In some instances, the sender may not want the communication forwarded for a variety of reasons, including, for example, an undesirable forwarded location, additional charges that may be incurred, or other considerations. It would accordingly be desirable to have a communication system that would overcome the above disadvantages.

### SUMMARY OF THE INVENTION

One aspect of the invention provides a method of operating a communication system. The method includes: receiving a communication request from a sender to a recipient, determining whether the recipient is in a communication forward mode, and determining communication forwarding information based on the communication request and the communication forwarding mode determination.

Another aspect of the invention provides a computer usable medium including a program for operating a communication system that includes: computer readable code for receiving a communication request from a sender to a recipient, computer readable code for determining whether the recipient is in a communication forward mode, and computer readable code for determining communication forwarding information based on the communication request and the communication forwarding mode determination.

Another aspect of the invention provides a communication system including means for receiving a communication request from a sender to a recipient, means for determining whether the recipient is in a communication forward mode, and means for determining communication forwarding information based on the communication request and the communication forwarding mode determination.

### BRIEF DESCRIPTION OF THE DRAWINGS

FIG. 1 is a schematic diagram of a communication system in accordance with one embodiment of the invention;

FIG. 2 is a flow chart of one embodiment of a method of operating a communication system in accordance with the invention;

FIG. 3 is a flow chart of one embodiment of a method of operating a communication system in accordance with the invention; and

FIG. 4 is a block diagram of an information handling system of a method of providing communication forwarding in accordance with the present invention.

### DESCRIPTION OF THE PREFERRED EMBODIMENT

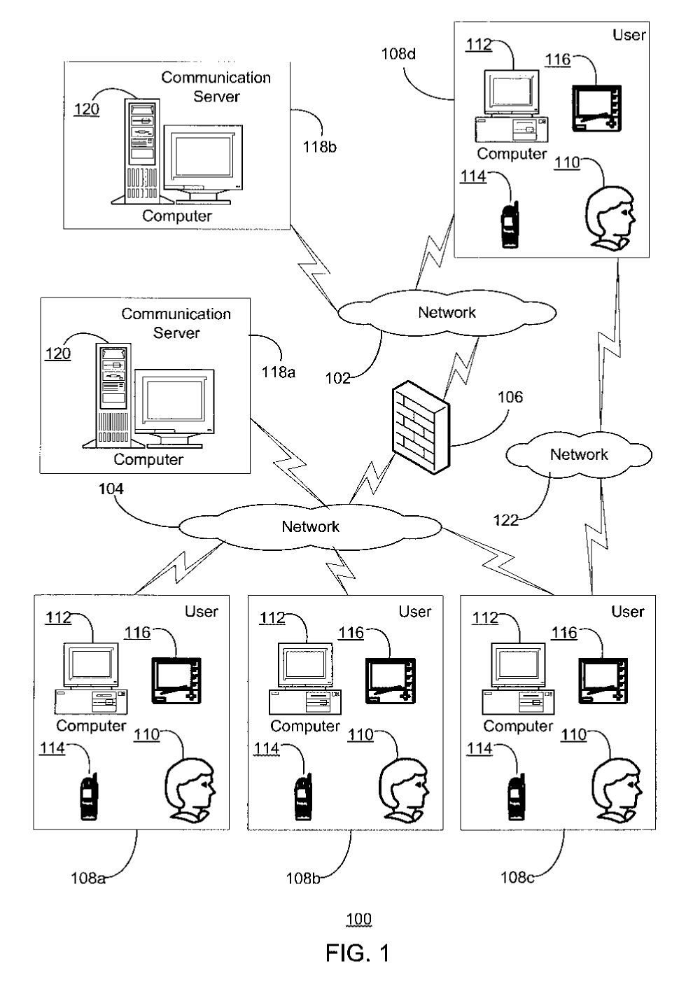

Referring to FIG. 1, a schematic diagram of a communication system in accordance with one embodiment of the present invention is generally shown at 100. Communication system 100 comprises network 102, and network 104. These networks are separated by firewall 106. Network 102 represents a public network, such as, for example, the Internet. Network 104 represents a private network, such as, for example, a company intranet. Links through and between networks 102 and 104 may include permanent connections (e.g., wire or fiber optic cables), temporary connections made through telephone, wireless or satellite communications, or various nodes of telecommunication system 100 may actually be hosted on the same physical hardware platform removing the necessity of a network link altogether. The networks may be in the form of public or private connections available over the Internet, an extranet, an intranet, a hard-wired local area network (LAN), a hard-wired wide area network (WAN), a wireless LAN, a wireless WAN, cellular network, satellite network, and/or other forms as would occur to those having ordinary skill in the art.

Networks 102 and 104 serve to provide communication between various network nodes, including user nodes 108a-d. Each user node may include an associated one or more persons 110, computers 112, cellular, landline, or internet phones 114, personal digital assistants 116, or other communication device as would occur to those having skill in the art.

User nodes 108a-c share private network 104, this network also including a communication server node 118a. A communication server node may include one or more computers 120 and other devices for facilitating communication between user nodes 108, as known in the art. A second communication server node 118b is shown on public network 102.

Communication server node 118 is used to facilitate communication between users on network 104 and users on network 102. To this end, communication server node 118 identifies and/or stores communication relevant information regarding networks 102 and 104 as well as the user node 108 is connecting the networks.

In one embodiment, user nodes 108 may communicate with each other over various networks directly, using peer-to-peer communication. User nodes 108 may also be directly connected by an additional telecommunication network 122 in the form of public switched telephone network, an integrated services digital network or a mobile ad-hoc network as would be appreciated by those having ordinary skill in the art.

Each user node 108 is capable of sending a communication request intended for another use node 108 in the form of a phone call, a facsimile, an email, an instant message or any other form was would be appreciated by those having ordinary skill in the art. To this end, each user node 108, each communication server 118 and telecommunication network 122 employs one or more communication channel switches (e.g., circuit switches, message switches, and packet switches) configured and programmed in accordance with the inventive principles of the present invention. In one embodiment, communication server 118 may be a switch, or perform switch functions. When a communication request is made from a sender to a recipient, the communication request includes a delivery location identifier for the intended recipient. For example, a phone communication/facsimile request would include a delivery location identifier in the form of a phone number or extension, an email communication request would include a delivery location identifier in the form of an email address, and an instant message communication request would include a delivery location identifier in the form of a screen name.

Communication forwarding can be activated by the intended recipient, by a system administrator, or by some other party with communication forwarding permission for the intended recipient. When communication forwarding is activated, a forward location can be specified that provides the alternate delivery location identifier to be used during forwarding. Alternatively, a default alternate delivery location identifier can be selected when communication forwarding is activated.

A communication forwarding feature may be desired, for example, if the one or more persons 110 associated with user node 108a are going to be at a location associated with, for example, user node 108b. One such situation may be when a first person is having a meeting in a second person's office they may wish to forward instant messages to the second person's office computer. By way of another example, a user may wish to forward communication requests directed at a landline office phone to a cell phone. Many more opportunities for communication forwarding exist that would be appreciated by one skilled in the art.

Communication forwarding can be cascaded if another forward occurs. For example, user node 108a can forward communication requests to user node 108b. User node 108b can forward communication requests to user node 108c. A communication request to user node 108a in this instance can be forwarded to user node 108c.

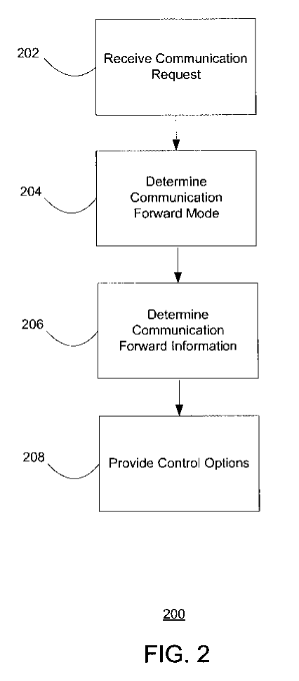

FIG. 2 is a flow chart of a method of operating a communication system in accordance with one embodiment of the invention, which is generally shown at 200. First, a communication request from a sender to a recipient is received (Block 202). It is then determined whether the recipient is in a communication forward mode (Block 204). Communication forwarding information is then determined based on the communication forwarding mode determination (Block 206). Control options are provided to the sender based on the determined communication forwarding information (Block 208).

In one embodiment, the communication request from a sender to a recipient is received at communication server node 118 (Block 202). Alternatively, the communication request is received at user node 108. When the communication request is received at user node 108, it may have passed through communication server node 118. The received communication request is a reception of one of many forms of communication including a phone communication request, fax, email, instant message, or the like. The communication request can be initiated, for example, by a sender dialing a destination number to place a phone call or to send a fax. Alternatively, the communication request can be initiated by a user selecting to send an instant message or email. In one embodiment, a communication request can also be initiated by a communication server or other network node. When the communication request is received, the receiving node determines whether the recipient is in communication forward mode (Block 204). The determination of communication forward mode is based on information stored at the receiving node and/or information on another node of communication system 100. For example, when receiving a communication request at communication server node 118, communication server node 118 can hold information related to the communication forward mode of the intended recipient. Alternatively, communication server node 118 requests a communication forward mode status from a second communication server, or from user node 108, the intended recipient. When receiving a communication request at user node 108, user node 108 can hold information related to the communication forward mode of the intended recipient. Alternatively, user node 108 requests a communication forward mode status from communication server node 118.

The determining of communication forward information (Block 206) is based on communication forward mode determination and the communication request. Specifically, the communication forward mode determination will specify a “Forward To” location by the recipient and the communication request can specify a “Sender Forward Approved Locations” list by the sender. In one embodiment the list of “Sender Forward Approved Locations” can be a list of user nodes 108. A communication forward request can be executed based on inclusion of the “Forward To” location in the “Sender Forward Approved Locations” list. Alternatively, the list of “Sender Forward Approved Locations” can be a list of, or include within the list, networks, domains, service providers, or the like. A communication forward request can be forwarded based on access to the “Forward To” location via the networks, domains, service providers, or the like in the “Sender Forward Approved Locations” list. The communication forward information is determined based on a comparison of the “Forward To” location by the recipient and the “Sender Forward Approved Locations” list by sender as will be further explained herein in conjunction with detailed forwarding scenarios related to FIG. 1.

In view of the comparison, the communication forward information can include a variety of data related to the forwarding of the communication request as would be appreciated by those having ordinary skill in the art. For example, communication forward information can include a forward location identity associated with the alternate delivery location identifier. A forward location identity includes information associated with the alternate delivery location such as, for example, physical location, alternate delivery location identifier, the names of one or more persons associated with the alternate delivery location, and the like.

Further data can be collected by or provided to communication server node 118 or user node 108, and can be provided as part of the communication forward information. For example, when a communication request is forwarded, it will pass through or traverse one or more networks to reach the alternate delivery location. Communication forward information can include a list of these networks, and can include an assigned security level associated with one or more of these networks. Security levels can be assigned by an administrator, determined based on network topology, or the like. Such information can be stored on communication server node 118, acting as or in conjunction with a network switch. User node 108a can send a communication request to user node 108b. User node 108b can have set communication forwarding to user node 108d. Communication server node 118 can then determine that forward security status information includes that network 102 will be included in the transmission instead of only network 104 as would have been the case had the communication request been received at user node 108b. Information regarding network security is one example of forward security status. Forward security status can include an identification of whether a telephone or fax communication will be transmitted over a secure line. Forward security status can also include information such as a security clearance associated with the forward location identity, or one or more persons associated with the forward location. Forward security status can indicate security protocols that will or may be applied in communication to the forward location. Forward security status can include any of these, or other information regarding the security of the transmission or forward location.

Communication forward information can also include a forward charge status. Forward charge status provides information related to costs associated with transmission to or reception at the forward location. For example, a phone communication request placed over an office phone network may not incur phone charges. If communication forwarding has been activated, the communication request can be forwarded to an outside line within system 100 that will incur phone charges. In one embodiment, communication server node 118 acts as a public telecommunication switch. When a communication request passes through a communication server node acting as a public telecommunication switch, the communication server node can have access to charge and rate information associated with a sender as would be appreciated by one having skill in the art. A forwarded communication request can be identified, the cost of communication to the new recipient determined, and forward charge status would indicate this cost.

In one embodiment, the providing of control options (Block 208) includes providing the control options to the sender, to a representative of the sender, to a system administrator, or some other party.

Control options provide the user an opportunity to select an option related to the communication request. Control options include, for example, send communication forward, cancel communication forward, forward with name visible, and forward with name not visible options. Control options for a phone call can be provided by pressing numbers associated with an option, or by speaking a number or other verbal representation of an option. Control options for an email or instant messaging communication can be provided as hyperlinks or buttons either within the contents of a message or within the email or instant messaging client. Further methods of providing control options exist that would be appreciated by one skilled in the art.

Control options can include communication forward information, or information related to the communication forward information. Communication forward information can be provided with the control options in a variety of ways. For example, for a phone communication the communication forward information can be presented as voice prompts. In an instant messaging or email system, communication forward information can be presented visually, for example as text.

The send communication forward control option can provide the option to allow the communication request to be forwarded to the communication forward location. The cancel communication forward control option can provide the option to the sender via a push button instruction to stop the communication request from being forwarded to the communication forward location. In one embodiment, when the cancel communication forward control option is selected, the communication request is not delivered to any location. Alternatively, the communication request can be delivered to the original intended recipient location. The forward with name visible control option can provide the option to forward the communication request including sender identification. The forward with name not visible control option can provide the option to forward the communication request while not providing sender identification. These and other communication forward options can be provided as would be appreciated by one skilled in the art.

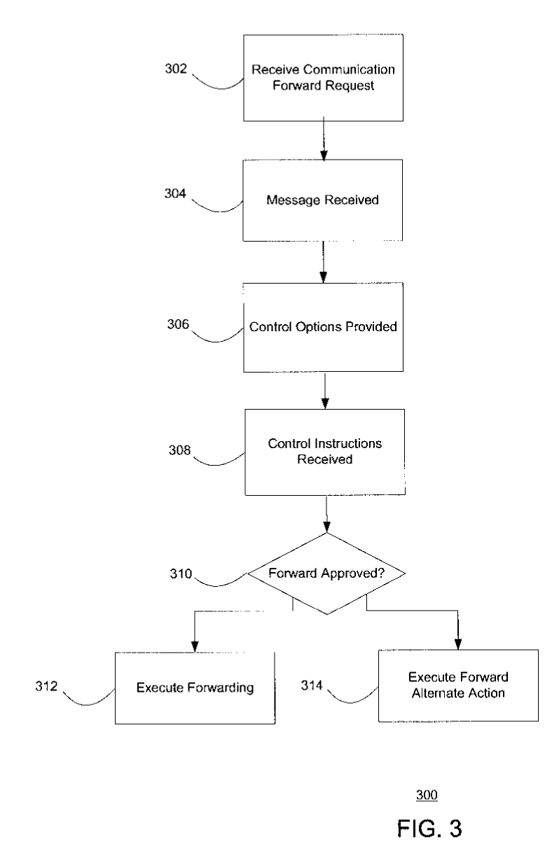

FIG. 3 is a flow chart of a method of operating a communication system made in accordance with one embodiment of the invention, which is generally shown at 300. The method includes the reception of control instructions and the execution of a step based on the received control instructions.

The method 300 includes receiving a communication forward request (Block 302), receiving a communication request (Block 304) from a sender to a recipient, providing control options (Block 306) to the sender based on determined communication forward information, receiving control instructions (Block 308) from the sender based on the control options, determining whether the forward has been approved (Block 310) based on the received control instructions, and based on the determination either executing the forward action (Block 312) or executing a forward alternate action (Block 314).

The receiving of the communication forward request (Block 302) may require authorization. For example, a username and password or a pin number can be required. The communication forward request can include one or more alternate delivery location identifiers. A communication forward request can be performed at the node that is to be forwarded, can be performed at the node that is to be the alternate delivery node, or can be performed at another location. For example, the user of user node 108a may be running an instant messaging application. When that user intends to move to an alternate location, such as a location associated with user node 108b, the user can send a communication forward request from a computer of user node 108a. Alternatively, if the user has not sent a communication forward request before moving to the location associated with user node 108b, they can enter a communication forward request for their instant messaging using the computer of user node 108b. Similar processes can be employed for email, phone communication request, or other types of communication forwarding.

In one embodiment, the receiving control instructions (Block 308) occurs at user node 108. Alternatively, the receiving control instructions can occur at a communication server node 118. The control instructions can be, in one embodiment, the reception of a selected control option. The control option selection can be made by the user of user node 108. Alternatively, the user node can be configured to select a control option based on specified call forward information. For example, the user can configure their node to allow communication forwarding when line charges are below fifteen cents per minute. Control instructions can include additional information such as authorization information, payment selection information, security selection information, or the like. Authorization information can include, for example, username and password, pin, biometric data, security key, or other forms of authorization as would be appreciated by one skilled in the art. Payment selection information can include, for example, credit card information, bank account information, communication requesting card information, or other forms of payment as would be appreciated by one skilled in the art. Security selection information can include, for example, a selection of a security protocol such as Kerberos, Triple Data Encryption Standard (3DES), SSL, or the like.

The determining of whether the forward has been approved (Block 310) can be based in whole or in part on the received control instructions. The approval status can be complete, or conditional. For example, the approval can allow the forward, but require that the senders name be hidden, or that a level of security be applied to the forwarded transmission.

When the communication forward has been approved, the executing of the forward action (Block 312) takes place. The forward action can include sending the communication request to the forward location. Alternatively, the forward action can include sending a signal to the forward location indicating that a forwarded message is inbound. When such an inbound message alert is received, the receiving node can be required to provide acceptance and/or authentication information in order to receive the forwarded communication request. For example, if a phone communication request has been forwarded, the phone 114 at the forward location can ring and on answer a message requesting a pin number of the original receiver can be played.

The executing of a forward alternate action (Block 314) is executed when communication forwarding is not approved. A forward alternate action can be, for example, the cancellation of the communication request. Alternatively, the forward alternate action can be delivery to the original delivery location.

The description of FIGS. 2 and 3 herein provide a general understanding of the inventive principles of the present invention. To facilitate a more detailed understanding of the inventive principles of the present invention, an operational description of forwarding a communication request in the form a communication request by user node 108a, intended for user node 108c, via communication server node 118a serving as a telecommunication switch will now be provided herein to facilitate a further understanding of how to implement the inventive principles of the methods of FIGS. 2 and 3.

Referring to FIG. 1, a communication request by user node 108a to user node 108c via communication server node 118a includes a location identifier of user node 108c as well as a “Forwarding Information Tag” of fields or flags specifying “Do Not Forward” or “Forward” or “Forward With Sender Approval”. If communication forwarding is applicable to user node 108c, a specification of “Do Not Forward” or “Forward” within the “Forwarding Information Tag” is executed by communication server node 118a as would be appreciated by those having ordinary skill in the art, and a specification of “Forward With Sender Approval” within the “Forwarding Information Tag” is executed by communication server node 118a based on a “Forward To Location” specification by user node 108c to communication server node 118a, a “Sender Forward Approved Locations” list by user node 108a that is also included within the communication request, and/or network security and/or toll information as known by communication server node 118a. The following are exemplary “Forward With Sender Approval” scenarios executed by communication server node 118a in view of a communication forwarding request by user node 108c.

Scenario 1 involves (1) user node 108d being the “Forward To Location” specified by user node 108c and (2) either an absence of any location in the “Sender Forward Approved Locations” list by user node 108a, or such list from user node 108a contains one or more entries and none of them are user node 108d, or networks, domains, service providers, or the like, that include user node 108d. In this case, upon a recognition that forwarding is required in response to the communication request from user node 108a, communication server node 118a will add user node 108d to the “Sender Forward Approved Locations” list whereby the communication request is returned to user node 108a with network security and/or toll information to enable user node 108a to decide whether or not to forward the communication request to user node 108d.

For example, communication server node 118a can receive a communication request in the form of a phone call placed from user node 108a. The communication server node then determines communication forward mode based on user node 108c as the intended recipient. This determination can be based on information associated with user node 108a that is stored on communication server node 118a, or alternatively the determination can be based on information collected from user node 108a by communication server node 118a. As user node 108d is specified as the “Forward To Location,” communication server 118a determines associated communication forward information. Prior to forwarding the communication request, communication server node 118a provides an audio instruction to user node 108a that “The call can be forwarded to user node 108d via a foreign toll network 102 with a charge of $3.50 per minute. The forwarding will traverse across low security analog networks 104 and 102. Press or say 1 to accept, and press or say 2 to cancel.” Communication server node 118a will forward the communication request to communication server node 118b on behalf of user node 108d in response to an acceptance selection by user node 108a, or terminate the communication request in response to a cancellation selection by user node 108a. Upon completion of the communication, user node 108d is removed from the “Sender Forward Approved Locations” list.

Scenario 2 involves (1) user node 108d being the “Forward To Location” specified by user node 108c and (2) user node 108d, or a network, domain, service provider, or the like, that includes user node 108d, being an entry in the “Sender Forward Approved Locations” list by user node 108a. In this case, upon a recognition that forwarding is required in response to the communication request from user node 108a, communication server node 118a will forward the communication request to communication server node 118b on behalf of user node 108a in accordance with user node 108d being specified by both user nodes 108a and 108c as the desired forwarding location.

Scenario 3 involves (1) user node 108d being the “Forward To Location” specified by user node 108c, (2) communication server 118a identifying communication server 118b as the next telecommunication switch in the communication path to user node 108d and (3a) communication server 118a requesting call forward information from communication server 118b and providing that information to user node 118a if it exists or (3b) communication server 118b providing call forward information to user node 118a if it exists. Either communication server node can supply the call forward information as described above, and based on received control instructions will forward or terminate the communication.

Scenarios 1, 2 and 3 can be repeated at each user node that specifies a re-forwarding of the communication request.

From the description of the aforementioned scenarios, those having ordinary skill in the art will appreciate how to implement the methods of FIGS. 2 and 3 for other communication systems, particularly systems more complex than system 100 shown in FIG. 1.

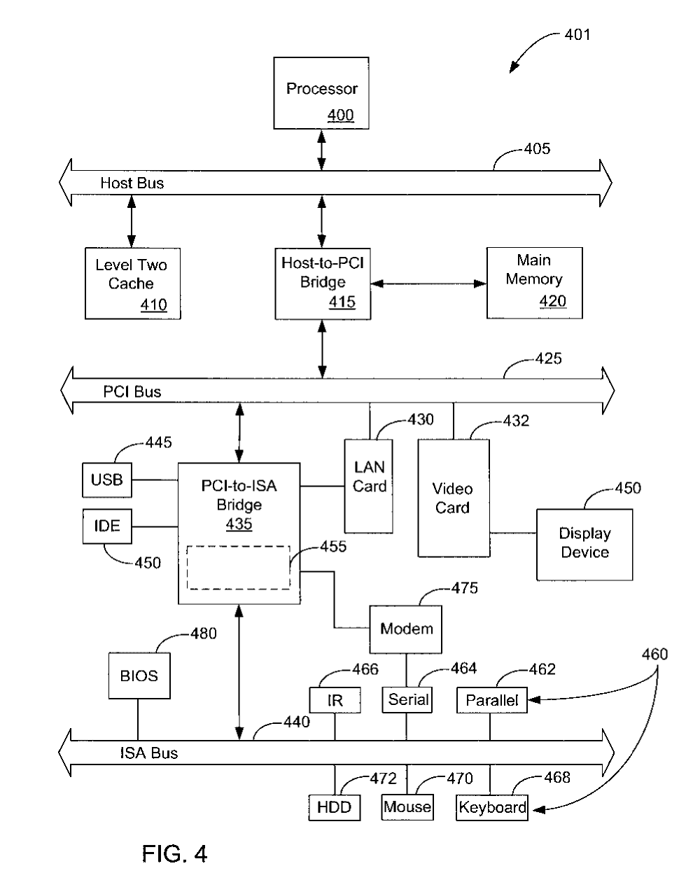

FIG. 4 is a block diagram of an information handling system for implementing a communication system in accordance with the present invention. The information handling system 401 is a simplified example of a computer system capable of performing the operations described herein. The information handling system 401 includes processor 400 which is coupled to host bus 405. A level two (L2) cache memory 410 is also coupled to the host bus 405. Host-to-PCI bridge 415 is coupled to main memory 420, includes cache memory and main memory control functions, and provides bus control to handle transfers among PCI bus 425, processor 400, L2 cache 410, main memory 420, and host bus 405. The PCI bus 425 provides an interface for a variety of devices including, for example, LAN card 430 and/or video card 432. The video card 432 is operably connected to a display device 490, such as a liquid crystal display (LCD), a cathode ray tube (CRT) display, a projection display, or the like. The display device 490 can be used to display communication system information in accordance with the present invention. Those skilled in the art will appreciate that the video card 432 can be attached to other types of busses, such as an AGP or a PCI Express bus, as desired for a particular application.

PCI-to-ISA bridge 435 provides bus control to handle transfers between the PCI bus 425 and ISA bus 440, universal serial bus (USB) functionality 445, IDE device functionality 450, power management functionality 455, and can include other functional elements not shown, such as a real-time clock (RTC), DMA control, interrupt support, and system management bus support. Peripheral devices and input/output (I/O) devices can be attached to various interfaces 460 (e.g., parallel interface 462, serial interface 464, infrared (IR) interface 466, keyboard interface 468, mouse interface 470, and fixed disk (HDD) 472) coupled to ISA bus 440. Alternatively, a super I/O controller (not shown) can be attached to the ISA bus 440 to accommodate many I/O devices.

BIOS 480 is coupled to ISA bus 440, and incorporates the necessary processor executable code for a variety of low-level system functions and system boot functions. The BIOS 480 can be stored in any computer readable medium, including magnetic storage media, optical storage media, flash memory, random access memory, read only memory, and communications media conveying signals encoding the instructions (e.g., signals from a network). In order to attach information handling system 401 to another computer system to copy files over a network, LAN card 430 is coupled to PCI bus 425 and to PCI-to-ISA bridge 435. Similarly, to connect computer system 401 to an ISP to connect to the Internet using a telephone line connection, modem 475 is connected to serial port 464 and PCI-to-ISA Bridge 435.

While the computer system described in FIG. 4 is capable of executing the invention described herein, this computer system is simply one example of a computer system. Those skilled in the art will appreciate that many other computer system designs are capable of performing the invention described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via

the Internet or other computer network. Thus, the present invention may be implemented as a computer program stored on a computer readable medium and executable by a digital processing apparatus to perform operations to display data. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

We claim:

1. A method of operating a communication system, the method comprising:
receiving a communication request from a sender to a recipient;
determining whether the recipient is in a communication forward mode; and
determining communication forwarding information based on the communication request and the communication forwarding mode determination.

2. The method of claim 1, wherein determining communication forwarding information based on the communication request and the communication forwarding mode determination includes:
identifying a forward location specification by the recipient;
identifying a list of sender approved forward locations by the sender; and
determining the communication forwarding information based a comparison of the forward location specification and the list of sender approved forward locations.

3. The method of claim 1, further comprising:
providing control options to the sender based on the determined communication forwarding information;
receiving control instructions from the sender based on the control options; and
forwarding the communication request based on the received control instructions.

4. The method of claim 1, wherein the communication request is received at a recipient communication device via a communication network.

5. The method of claim 1, wherein the communication request is received at a communication server via a communication network.

6. The method of claim 1, wherein determining communication forwarding information includes:
determining a communication forward location identity.

7. The method of claim 1, wherein determining communication forwarding information includes:
determining a communication forward security status.

8. The method of claim 1 wherein determining communication forwarding information comprises:
determining a communication forward charge status.

9. The method of claim 1, wherein providing control options to the sender includes:
providing one or more options selected from a list consisting of cancel communication forward, forward with name visible, and forward with name not visible.

10. A computer usable medium including a program for operating a communication system, comprising:
computer readable code for receiving a communication request from a sender to a recipient;
computer readable code for determining whether the recipient is in a communication forward mode; and
computer readable code for determining communication forwarding information based on the communication request and the communication forwarding mode determination.

11. The method of claim 10, wherein the computer readable code for determining communication forwarding information based on the communication request and the communication forwarding mode determination includes:
computer readable code for identifying a forward location specification by the recipient;
computer readable code for identifying a list of sender approved forward locations by the sender; and
computer readable code for determining the communication forwarding information based a comparison of the forward location specification and the list of sender approved forward locations.

12. The computer usable medium of claim 10, further comprising:
computer readable code for providing control options to the sender based on the determined communication forwarding information;
computer readable code for receiving control instructions from the sender based on the control options; and
computer readable code for forwarding the communication request based on the received control instructions.

13. The computer usable medium of claim 10, wherein the communication request is received at a recipient communication device via a communication network.

14. The computer usable medium of claim 13, wherein the communication forward mode determination is made at the recipient communication device.

15. The computer usable medium of claim 10, wherein the communication request is received at a communication server via a communication network.

16. The computer usable medium of claim 15, wherein the communication forward mode determination is made at the communication server.

17. The computer usable medium of claim 10, wherein determining communication forwarding information includes:
determining a communication forward location identity.

18. The computer usable medium of claim 10, wherein determining communication forwarding information includes:
determining a communication forward security status.

19. The computer usable medium of claim 10, wherein determining communication forwarding information includes:
determining a communication forward charge status.

20. A communication system, comprising:
means for receiving a communication request from a sender to a recipient;
means for determining whether the recipient is in a communication forward mode;
means for determining communication forwarding information based on the communication request and the communication forwarding mode determination.
